(19) United States
(12) Patent Application Publication
(10) Pub. No.: US 2026/0003044 A1
(43) Pub. Date: Jan. 1, 2026

(54) Histogram-based Light Detection and Ranging System and Method Thereof

(71) Applicant: Compertum Microsystems Inc., Hsinchu City (TW)

(72) Inventor: Francis Piu MAN, Hsinchu City (TW)

(73) Assignee: Compertum Microsystems Inc., Hsinchu City (TW)

(21) Appl. No.: 18/757,482

(22) Filed: Jun. 27, 2024

(51) Int. Cl. G01S 7/4865; G01S 7/481; G01S 17/10

(52) U.S. Cl. CPC G01S 7/4866; G01S 7/4812; G01S 17/10

(57) ABSTRACT

A LiDAR system and a LiDAR method are disclosed. The LiDAR system includes an emitter, configured to emit a train of pulses, and a detector, configured to detect noise pulses and a train of returned pulses. A time delay between each pulse and each returned pulse is calculated; a time delay between each pulse and each noise pulse is calculated. a data group is created according to the time delays between the pulses and the returned pulses and the time delays between the pulses and the noise pulses. The returned pulses are distinguished from the noise pulses according to the data group.

### BACKGROUND OF THE INVENTION

### 1. Field of the Invention

The present invention relates generally to Light Detection and Ranging (LiDAR) for surveying its surrounding environment.

### 2. Description of the Prior Art

With the advent of Autonomous Driving Assist System (ADAS), automobiles demand LiDAR that can reliably sense and identify objects, hazards, and obstacles over long range. Essentially LiDAR emits non-visible laser pulses to objects within the field of view (FOV) and detects returned pulse signals. The distances to objects are then computed by measuring time delays between emitted and returned pulses.

However, sunlight can interfere with this process, sometimes being undesirably detected and mistakenly considered as returned pulses. Therefore, there is a need for a new type of LiDAR that is insensitive to sunlight.

### SUMMARY OF THE INVENTION

An embodiment of the present disclosure provides a Light Detection and Ranging (LiDAR) system, comprising an emitter, configured to emit a train of pulses; and a detector, configured to detect noise pulses and a train of returned pulses, wherein a time delay between each pulse and each returned pulse is calculated, wherein a time delay between each pulse and each noise pulse is calculated, wherein a data group is created according to the time delays between the pulses and the returned pulses and the time delays between the pulses and the noise pulses, wherein the returned pulses are distinguished from the noise pulses according to the data group.

Another embodiment of the present disclosure provides a Light Detection and Ranging (LiDAR) method, configured for a LiDAR system, and the LiDAR method comprises emitting a train of pulses; and detecting noise pulses and a train of returned pulses, wherein a time delay between each pulse and each returned pulse is calculated, wherein a time delay between each pulse and each noise pulse is calculated, wherein a data group is created according to the time delays between the pulses and the returned pulses and the time delays between the pulses and the noise pulses, wherein the returned pulses are distinguished from the noise pulses according to the data group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a LiDAR system according to an embodiment of the present invention.

FIG. 2 is a timing diagram for laser pulse emission and returned pulse detection according to an embodiment of the present invention.

FIG. 3 is a schematic diagram of a LiDAR system according to an embodiment of the present invention.

FIG. 4 is a timing diagram for laser pulse emission and returned pulse detection according to an embodiment of the present invention.

FIG. 5 is a schematic diagram of a LiDAR system according to an embodiment of the present invention.

FIG. 6 is a timing diagram for laser pulse emission and returned pulse detection according to an embodiment of the present invention.

FIG. 7 is a histogram according to an embodiment of the present invention.

FIG. 8 is a timing diagram for laser pulse emission and returned pulse detection according to an embodiment of the present invention.

FIG. 9 is a histogram according to an embodiment of the present invention.

### DETAILED DESCRIPTION

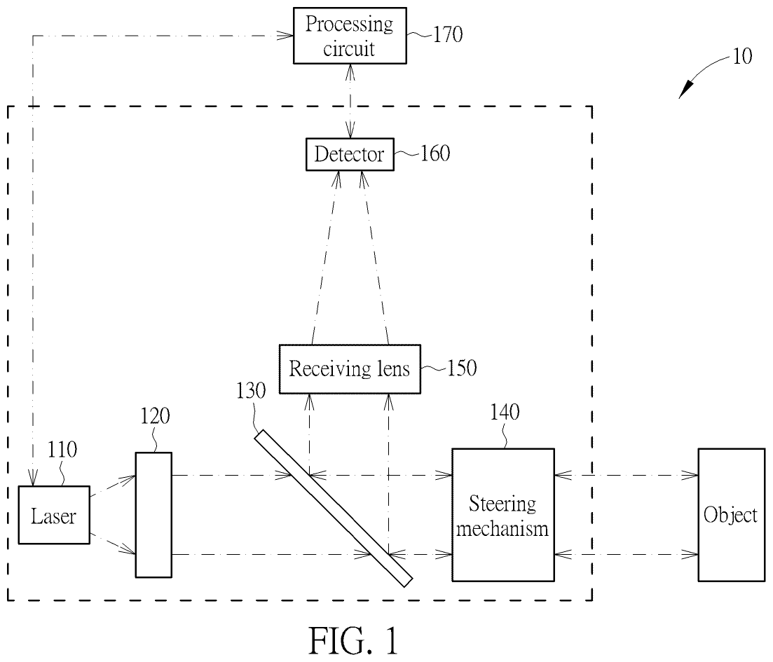

FIG. 1 is a schematic diagram of a LiDAR system 10 according to an embodiment of the present invention. The LiDAR system 10, which may be classified as coaxial, comprises an emitter 110, an optical directing units 120, 150, an optical coupler 130, a steering unit 140, a detector 160, and a processing circuit 170.

The emitter 110, which may be a laser source, emits non-visible pulsed or a train of pulsed laser beams. The wavelength of the emitter 110 typically falls within the range of 840, 905, 940, or 1550 nm.

The optical directing unit 120 may be a collimation lens. The light from the emitter 110 becomes a collimated light beam after passing through the collimation lens 120.

The steering unit 140, configured to steer the light or the reflected light, may comprise a resonant mirror, a motor-driven rotating polygon mirror, or a motor-driven rotating Reigh prism. The collimated light beam passing through the optical coupler 130 is directed at certain angle by the steering unit 140, which scans through one-dimensional (1D) or two-dimensional (2D) space to establish a corresponding 1D or 2D FOV. Upon hitting a (target) object, the collimated beam is reflected back and is subsequently received by the steering unit 140.

The optical coupler 130, configured to direct the outgoing pulsed laser to the steering unit 140 or reflect the returned pulsed laser to the optical directing unit 150, may be a combining mirror, a beam-splitter, a polarizing beam-splitter (PBS), or a mirror with an opening in the middle to allow the outgoing pulsed laser to pass through. A surface of the optical coupler 130, facing the steering unit 140 and the optical directing unit 150, may be a reflective/mirror surface that redirects incoming reflected beam towards the optical directing unit 150.

The optical directing unit 150, configured to converge incoming beam toward the detector 160, may be a receiving lens.

The detector 160, configured to convert the optical pulse signals into current pulses, may be avalanche photodiode(s) (APD), silicon photomultiplier(s) (SiPM), or single-photon avalanche diode(s) (SPAD). The detector 160 may be connected to trans-impedance amplifier(s) (TIA), which further convert(s) the current pulses to voltage pulses.

The processing circuit 170 may calculate the distance between the (target) object and the LiDAR system 10 by measuring the time difference between the outgoing and returned voltage pulses.

The LiDAR system 10 is classified as coaxial since the outgoing and returned laser beams are substantially coaxial/aligned/parallel to each other and share the same optical path (e.g., double arrow dash dot lines in FIG. 1).

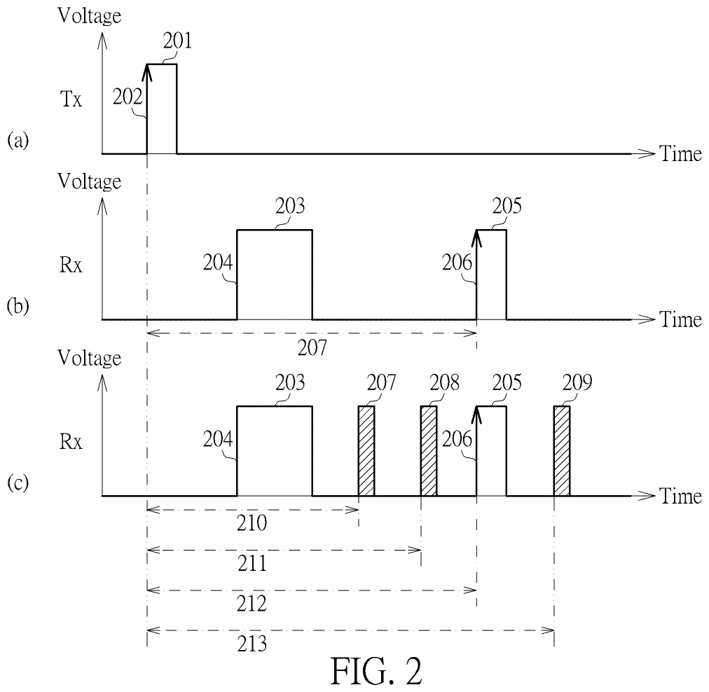

FIG. 2 is a timing diagram for laser pulse emission and returned pulse detection according to an embodiment of the present invention. FIG. 2 (a) illustrates the laser pulse emission (Tx). FIG. 2 (b) illustrates the returned pulse detection (Rx) without the influence of sunlight. FIG. 2 (c) illustrates the returned pulse detection (Rx) of a LiDAR system (e.g., 10) in a coaxial configuration under the influence of sunlight.

As shown in FIG. 2 (a), upon receiving a (triggered rising edge) signal 202, an emitter (e.g., 110) emits a non-visible pulsed laser beam 201.

Under a coaxial configuration (e.g., FIG. 1), a detector (e.g., 160), as shown in FIG. 2 (b), may receive two (or more) returned pulses (e.g., 203 and 205), in response to the emitted pulse 201.

The (first) returned pulse 203 corresponds to a stray optical beam. For example, while most of the light passes through an optical coupler (e.g., 130) toward a (target) object, a small portion of light is reflected toward an optical directing unit (e.g., 150). For example, the outgoing beam may reflect off the sidewall of an opening of the optical coupler (130) towards the optical directing unit (150). Another source of the stray optical beam occurs when the outgoing beam hits a steering unit (e.g., 140) and reflected back. Since these stray optical beams are received by the detector (160), the returned pulse 203 is observed at the detector (160).

The (second) returned pulse 205 corresponds to the desirable signal, which is the emitted pulse 201 reflected from the target object. The time delay 207 between the rising edge 202 of the emitted pulse 201 and the rising edge 206 of the returned pulse 205 indicates the total time traveling between the LiDAR system (10) and the target object, which in turns corresponds to the distance between them.

While the coaxial configuration may produce the undesirable stray optical pulse 203, it has the advantage of being less susceptible to sunlight interference since only sunlight beams coaxial to the laser transmitting pulse 202 is received by the detector (160).

For example, instead of receiving only two returned pulses (i.e., the stray optical beam 204 and the desirable target pulse 205, which corresponds to the correct time delay measurement 207), the LiDAR system (10) also detects undesirable sunlight/noise pulses 507, 508, and 509, which correspond to false time delay measurements 210, 211, and 213, respectively. In this noisy environment, the signal 205 is buried or obscured by the additional noise pulses 507, 508, and 509, resulting in the signal-to-noise ratio (SNR) approximately equal to 1.

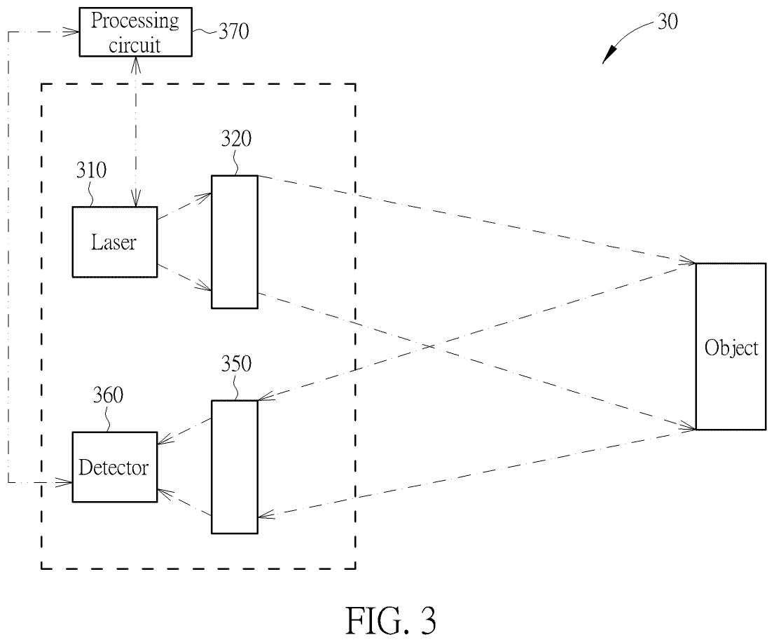

FIG. 3 is a schematic diagram of a LiDAR system 30 according to an embodiment of the present invention. The LiDAR system 30, which may be classified as non-coaxial (e.g., a flash LiDAR), comprises an emitter 310, an optical directing units 320, 350, a detector 360, and a processing circuit 370, which may be implemented using the emitter 110, the optical directing units 120, 150, the detector 160, and the processing circuit 170, respectively.

The emitter 310 emits non-visible pulsed or a train of pulsed laser beams, which form a light beam that illuminates the entire FOV through the optical directing unit 320. The wavelength of the laser beam may be 840, 905, 940, or 1550 nm.

The optical directing unit 350 enables the detector 360 to cover a large FOV, potentially encompassing the entire FOV. Specifically, upon hitting an object, the beam is reflected and captured by the detector 360 through the optical directing unit 350. The optical directing unit 350 converges the incoming beam toward the detector 360, which then converts the optical pulse signals to current pulses.

The detector 360 may be APD(s), SIPM(s), or SPAD(s), and is connected to TIA(s), which further convert(s) the current pulses into voltage pulses.

The processing circuit 370 determines the distance between the object and the LiDAR system 30 by measuring the time difference between the outgoing and returned voltage pulses.

The LiDAR system 30 is classified as non-coaxial since the outgoing and returned laser beams are not coaxial to each other and does not share the same optical path.

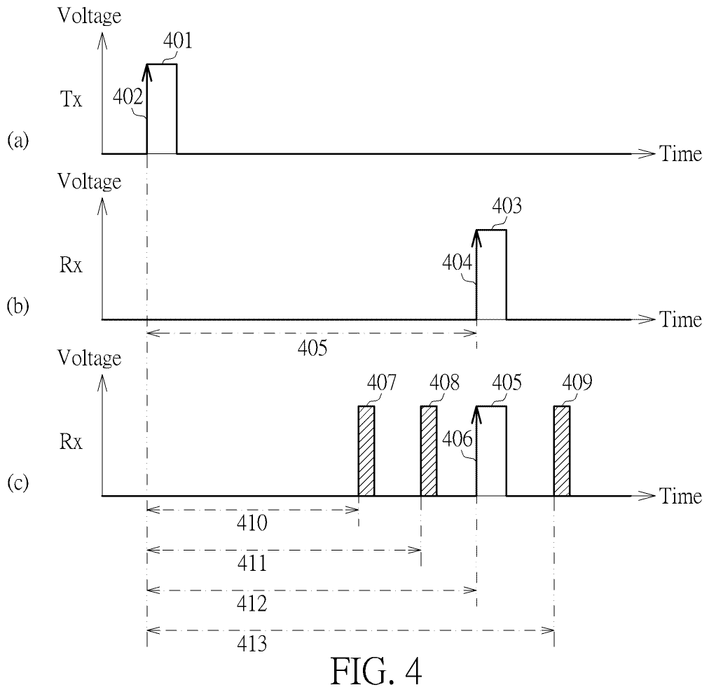

FIG. 4 is a timing diagram for laser pulse emission and returned pulse detection according to an embodiment of the present invention. FIG. 4 (a) illustrates the laser pulse emission (Tx). FIG. 4 (b) illustrates the returned pulse detection (Rx) without the influence of sunlight. FIG. 4 (c) illustrates the returned pulse detection (Rx) of a LiDAR system (e.g., 30) in a non-coaxial configuration under the influence of sunlight.

The distance to a target object can be determined according to FIG. 4. Specifically, as shown in FIG. 4 (a), upon receiving a triggered rising edge signal 402, an emitter (e.g., 310) emits a non-visible pulsed laser beam 401. Unlike a coaxial configuration, a non-coaxial LiDAR (e.g., FIG. 3) does not receive any stray optical pulse. Instead, as shown in FIG. 4 (b), a detector (e.g., 360) may receive only one returned pulse 403, which corresponds to the returned pulse reflecting off the target object. The time delay 405 between the rising edge 402 of the emitted pulse 401 and the rising edge 404 of the returned pulse 403 indicates the total time traveling between the LiDAR system (e.g., 30) and the target object, which in turns corresponds to the distance therebetween.

A drawback of a non-coaxial configuration (e.g., FIG. 3) is its susceptibility to sunlight interference, since any sunlight within the FOV will be received by the detector (360).

For example, instead of receiving only one returned pulse (i.e., the desirable target pulse 403 corresponding to the correct time delay measurement 405), the LiDAR system (10), under sunlight, also detects undesirable sunlight/noise pulses 407, 408, and 409, leading to false time delay measurements 410, 411, and 413. The signal 403 is buried in the noisy environment (i.e., 407, 408, and 409) such that the SNR approximates 1.

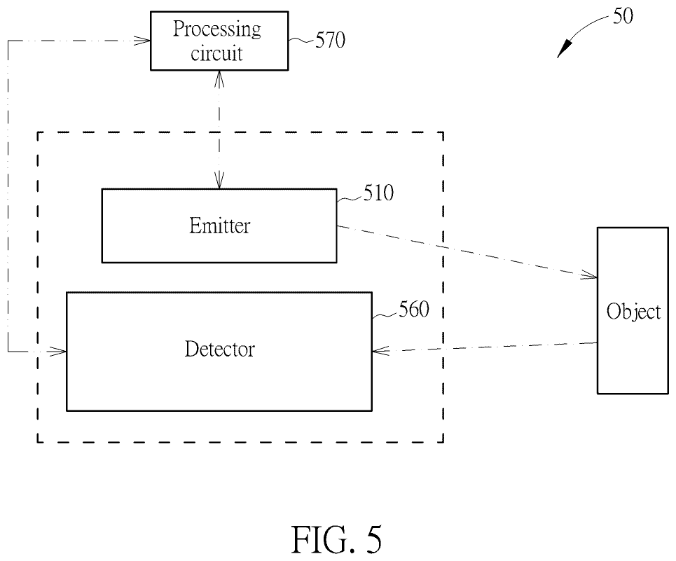

A LiDAR system must be meticulously designed to distinguish the correct time delay (e.g., 207 or 405) from other false time delays (e.g., 210, 211, 213, 410, 411, or 413) due to sunlight interference. For example, FIG. 5 is a schematic diagram of a LiDAR system 50 according to an embodiment of the present invention. The LiDAR system 50, which may be classified as coaxial or non-coaxial, comprises an emitter 510, a detector 560, and a processing circuit 570, which may be implemented using the emitter 110 (or 310), the detector 160 (or 360), and the processing circuit 170 (or 370), respectively.

The emitter 510 is configured to emit a train of pulses (e.g., 601-603, 801-803, or 1001-1005). The pulses may be non-visible light.

The detector 560 may be APD(s), SIPM(s), or SPAD(s), and may be connected to TIA(s). The detector 560 is configured to detect noise pulses (e.g., 621-623, 821-823, or 1021-1023) and a train of returned pulses (612-614, 618-620, 818-820, or 1028-1022). A returned pulse is non-visible light; a noise pulse may be visible or non-visible light. A returned pulse may represent light (e.g., 612, 613, or 614), which is emitted from the emitter 510 and reflected by an object, or light, which is emitted from the emitter 510 (e.g., 601-603) and reflected by component(s) within the LiDAR system 50. A noise pulse may be sunlight or environment noise.

The processing circuit 570 (e.g., a server, a microprocessor, a central processing unit (CPU), a graphics processing unit (GPU), or a neural-network processing unit (NPU)) is configured to compute the distance to the object using data from the emitter 510 or the detector 560. The processing circuit 570 may be disposed inside the LiDAR system 50, or externally to be communicatively coupled to the LiDAR system 50.

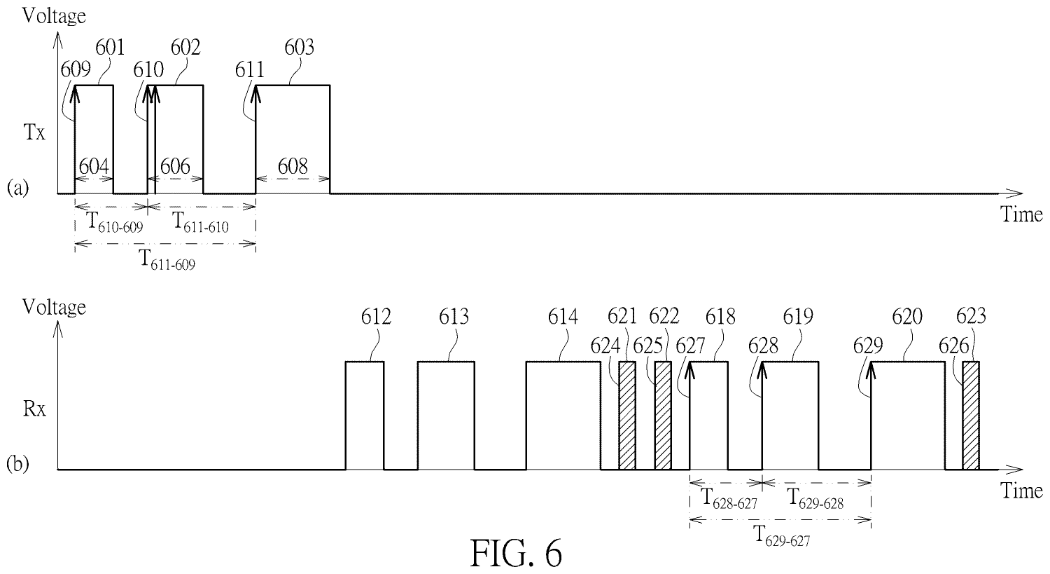

FIG. 6 is a timing diagram for laser pulse emission and returned pulse detection according to an embodiment of the present invention. FIG. 6 (a) illustrates the laser pulse emission (Tx). FIG. 6 (b) illustrates the returned pulse detection (Rx) of a LiDAR system (e.g., 50) in a coaxial configuration under the influence of sunlight.

As shown in FIG. 6 (a), upon receiving a triggered signal (e.g., 609), an emitter (e.g., 510) emits a train of arbitrary number of non-visible pulsed laser beams 601-603.

Under a coaxial configuration (e.g., FIG. 5), a detector (e.g., 560), as shown in FIG. 6 (b), may receive not only two returned pulses for each emitted pulse but also noise pulses. For example, an emitted pulse 601 is reflected to form a (first) returned pulse 612 and a (second) returned pulse 618. An emitted pulse 602 is reflected to form a (first) returned pulse 613 and a (second) returned pulse 619. An emitted pulse 603 is reflected to form a (first) returned pulse 614 and a (second) returned pulse 620.

The (second) returned pulse 618-620 correspond to the desirable returned pulses, which are the result of the emitted pulses 601-603 striking a target object. The time delay (e.g., T₆₂₇₋₆₀₉) between an emitted pulse (e.g., the rising edge 609 of the emitted pulse 601) and a returned pulse (e.g., the rising edge 627 of an emitted pulse 618) is calculated and listed in Table 1, facilitating the determination of the distance to the target object.

Noise pulses 621-623 correspond to interference from, for example, sunlight. The time delay (e.g., T₆₂₄₋₆₀₉) between an emitted pulse (e.g., the rising edge 609 of the emitted pulse 601) and a noise pulse (e.g., the rising edge 624 of an emitted pulse 621) is calculated and listed in Table 1.

TABLE 1

| | | Noise | Noise | Returned | Returned | Returned | Noise |
|---|---|---|---|---|---|---|---|
| | | pulse | pulse | pulses | pulses | pulses | pulse |
| | | 621 | 622 | 618 | 619 | 620 | 623 |
| Emitted | Rising | Rising Edge | | | | | |
| Pulses | Edge | 624 | 625 | 627 | 628 | 629 | 626 |
| 601 | 609 | T₆₂₄₋₆₀₉ | T₆₂₅₋₆₀₉ | T₆₂₇₋₆₀₉ | T₆₂₈₋₆₀₉ | T₆₂₉₋₆₀₉ | T₆₂₆₋₆₀₉ |
| 602 | 610 | T₆₂₄₋₆₁₀ | T₆₂₅₋₆₁₀ | T₆₂₇₋₆₁₀ | T₆₂₈₋₆₁₀ | T₆₂₉₋₆₁₀ | T₆₂₆₋₆₁₀ |
| 603 | 611 | T₆₂₄₋₆₁₁ | T₆₂₅₋₆₁₁ | T₆₂₇₋₆₁₁ | T₆₂₈₋₆₁₁ | T₆₂₉₋₆₁₁ | T₆₂₆₋₆₁₁ |

There are ways to distinguish desired returned pulses from interference noises.

In an embodiment, desired returned pulses are distinguished from noise pulses according to a highest peak of a histogram. The histogram is created according to all the time delays, each of which may satisfy T_{Rising_edge_Returned_pulse}−T_{Rising_edge_Emitted_pulse}=T_{Rising_edge_Returned_pulse-Rising_edge_Emitted_pulse} (equation 1) or T_{Rising_edge_Noise_pulse}−T_{Rising_edge_Emitted_pulse}=T_{Rising_edge_Noise_pulse-Rising_edge_Emitted_pulse} (equation 2). In other words, the histogram may comprise the time delays (e.g., T₆₂₇₋₆₀₉, T₆₂₇₋₆₁₀, T₆₂₇₋₆₁₁, T₆₂₈₋₆₀₉, T₆₂₈₋₆₁₀, T₆₂₈₋₆₁₁, T₆₂₉₋₆₀₉, T₆₂₉₋₆₁₀, or T₆₂₉₋₆₁₁) between the emitted pulses and the returned pulses and the time delays (e.g., T₆₂₄₋₆₀₉, T₆₂₄₋₆₁₀, T₆₂₄₋₆₁₁, T₆₂₅₋₆₀₉, T₆₂₅₋₆₁₀, T₆₂₅₋₆₁₁, T₆₂₆₋₆₀₉, T₆₂₆₋₆₁₀, or T₆₂₆₋₆₁₁) between the emitted pulses and the noise pulses.

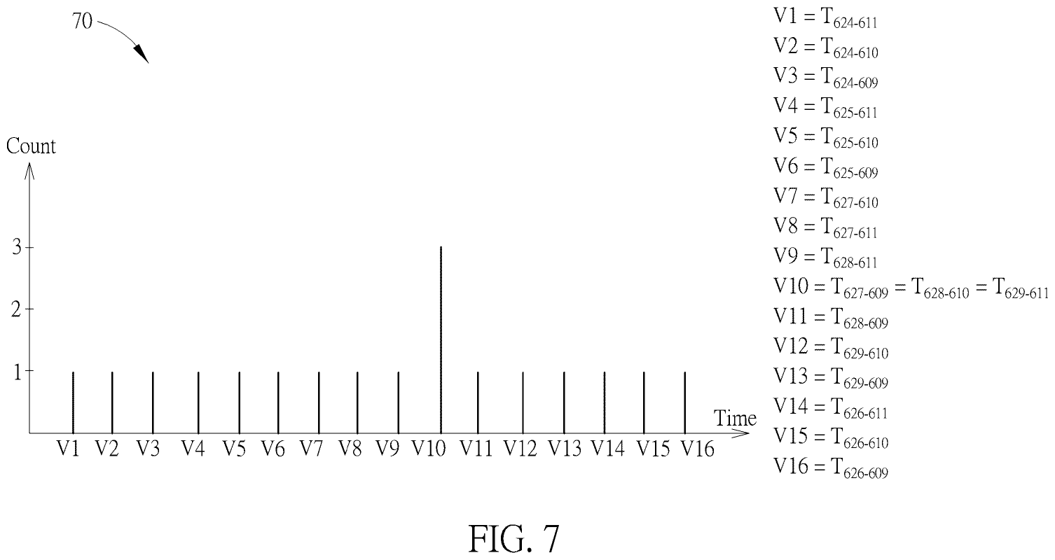

For example, FIG. 7 is a histogram 70 of time delays according to an embodiment of the present invention. To construct the histogram 70 with all the time delays, the first step is to divide the values (e.g., V1-V16) of the time delays into different bins (e.g., 16 bins), and then count the number of time delays which fall into each bin, to sort the time delays into the bins. Each bin, which is represented as a bar on the histogram 70, corresponds to the value of a time delay. In FIG. 7, the x-axis represents time delay values (i.e., the bins), and the y-axis (or the height of a bar) represents the count of time delays in each bin.

As shown in FIG. 7, most time delays (e.g., T₆₂₇₋₆₁₀, T₆₂₇₋₆₁₁, T₆₂₈₋₆₀₉, T₆₂₈₋₆₁₁, T₆₂₉₋₆₀₉, T₆₂₉₋₆₁₀, T₆₂₄₋₆₀₉, T₆₂₄₋₆₁₀, T₆₂₄₋₆₁₁, T₆₂₅₋₆₀₉, T₆₂₅₋₆₁₀, T₆₂₅₋₆₁₁, T₆₂₆₋₆₀₉, T₆₂₆₋₆₁₀, or T₆₂₆₋₆₁₁) are unequal, and thus the bars for the bins of the values V1-V9 and V11-V16 may reach up to 1 on the y-axis, meaning that there is only 1 data point in a bin. For example, if the time delays among all the emitted pulses are different, an emitted pulse and a returned (or noise) pulse, which is unrelated to the emitted pulse, hardly have a time delay equal to another.

Since, among all the time delays, the time delays T₆₂₇₋₆₀₉, T₆₂₈₋₆₁₀, and T₆₂₉₋₆₁₁ are substantially equal (within the margin of measuring errors), 3 counts (i.e., the number of occurrences of a time delay value) fall into the bin of the value V10, which equals the time delays T₆₂₇₋₆₀₉, T₆₂₈₋₆₁₀, and T₆₂₉₋₆₁₁. The tallest bar for the time delay value V10 with a height of 3 indicates that the most common time delay value is V10, and the number of occurrences of the value V10 is 3. In an embodiment, because the bar which corresponds to the value V10 is tallest (i.e., the highest peak of the histogram 70), the time delay (e.g., T₆₂₇₋₆₀₉) indicates an emitted pulse (e.g., 609) and its returned pulse (e.g., 627) (instead of a noise pulse). In another embodiment, because the height of the bar (i.e., the peak value of the highest peak) equals the number of emitted pulses (i.e., 3), the time delay (e.g., T₆₂₇₋₆₀₉) indicates an emitted pulse (e.g., 609) and its returned pulse (e.g., 627) (instead of a noise pulse).

As a result, the returned pulses 627-629 can be distinguished from the noise pulses 621-623 by the time delays corresponding to the highest peak (or by the counts of the bin equal to the number of emitted pulses). Besides, the distance to the target object can be calculated according to the time delay (e.g., T₆₂₇₋₆₀₉, T₆₂₈₋₆₁₀, or T₆₂₉₋₆₁₁) corresponding to the highest peak (or a predetermined count).

Furthermore, if the number of the emitted pulses is 3, the SNR equals 3. The SNR may be improved as number of emitted pulses increases.

In an embodiment, desired returned pulses are distinguished from noise pulses according to the maximum count of time delays in a statistic table. The statistic table is created according to all the time delays, which comprise the time delays (e.g., T₆₂₇₋₆₀₉, T₆₂₇₋₆₁₀, T₆₂₇₋₆₁₁, T₆₂₈₋₆₀₉, T₆₂₈₋₆₁₀, T₆₂₈₋₆₁₁, T₆₂₉₋₆₀₉, T₆₂₉₋₆₁₀, or T₆₂₉₋₆₁₁) between the emitted pulses and the returned pulses and the time delays (e.g., T₆₂₄₋₆₀₉, T₆₂₄₋₆₁₀, T₆₂₄₋₆₁₁, T₆₂₅₋₆₀₉, T₆₂₅₋₆₁₀, T₆₂₅₋₆₁₁, T₆₂₆₋₆₀₉, T₆₂₆₋₆₁₀, or T₆₂₆₋₆₁₁) between the emitted pulses and the noise pulses.

The statistic table may be implemented using Table 2. As listed in Table 2, because the count of time delays is the largest or equal to the number of emitted pulses (i.e., 3), the corresponding time delay (e.g., T₆₂₇₋₆₀₉) indicates an emitted pulse (e.g., 609) and its returned pulse (e.g., 627).

TABLE 2

| time delay | count of time delays |
|---|---|
| T₆₂₄₋₆₁₁ | 1 |
| T₆₂₄₋₆₁₀ | 1 |
| T₆₂₄₋₆₀₉ | 1 |
| T₆₂₅₋₆₁₁ | 1 |
| T₆₂₅₋₆₁₀ | 1 |
| T₆₂₅₋₆₀₉ | 1 |
| T₆₂₇₋₆₁₀ | 1 |
| T₆₂₇₋₆₁₁ | 1 |
| T₆₂₈₋₆₁₁ | 1 |
| T₆₂₇₋₆₀₉ = T₆₂₈₋₆₁₀ = T₆₂₉₋₆₁₁ | 3 |
| T₆₂₈₋₆₀₉ | 1 |
| T₆₂₉₋₆₁₀ | 1 |
| T₆₂₉₋₆₀₉ | 1 |
| T₆₂₆₋₆₁₁ | 1 |
| T₆₂₆₋₆₁₀ | 1 |
| T₆₂₆₋₆₀₉ | 1 |

Please refer back to FIG. 6. As shown in FIG. 6, each emitted pulse (e.g., 601, 602, or 603) has its rising edges (e.g., 609, 610, or 611) and its pulse width (e.g., 604, 606, or 608).

The pulse widths of the emitted pulses 601-603 may be identical, different, arbitrary, or random. Correspondingly, the pulse widths of the returned pulse 618-620 (or 612-614) may be identical, different, arbitrary, or random. Each of the returned pulses 618-620 and 612-614 substantially has the same pulse width as one of the emitted pulses 601-603. Each of the emitted pulses 601-603 substantially has the same pulse width as at least one of the returned pulses 618-620 and 612-614.

The waveform of an emitted pulse (e.g., 601, 602, or 603) may be take various forms, such as sinusoidal, square, rectangular, saw-tooth, or triangle. The waveform of a returned pulse (e.g., 618, 619, 620, 612, 613, or 614) substantially matches or resembles the waveform of its corresponding emitted pulse (e.g., 601, 602, or 603).

The time delays (e.g., T₆₁₀₋₆₀₉, T₆₁₁₋₆₁₀, T₆₁₁₋₆₀₉) between the emitted pulses 601-603 may be identical, different, arbitrary, or random. Correspondingly, the time delays (e.g., T₆₂₈₋₆₂₇, T₆₂₉₋₆₂₈, T₆₂₉₋₆₂₇) between the returned pulse 618-620 (or 612-614) may be identical, different, arbitrary, or random. The time delay between two of the returned pulses 618-620 (or 612-614) is substantially the same as the time delay between two of the emitted pulses 601-603.

The (first) returned pulses 612-614 corresponds to stray optical beams. The time delays between a (first) returned pulses (e.g., 612, 613, or 614) and its corresponding emitted pulse (e.g., 601, 602, or 603) may be short enough to be negligible.

Unlike a coaxial configuration, where the number of the returned pulses equals an integer multiple (e.g., 2, 3, or 4) of the number of the emitted pulses, the number of the returned pulses in a non-coaxial configuration equals the number of the emitted pulses.

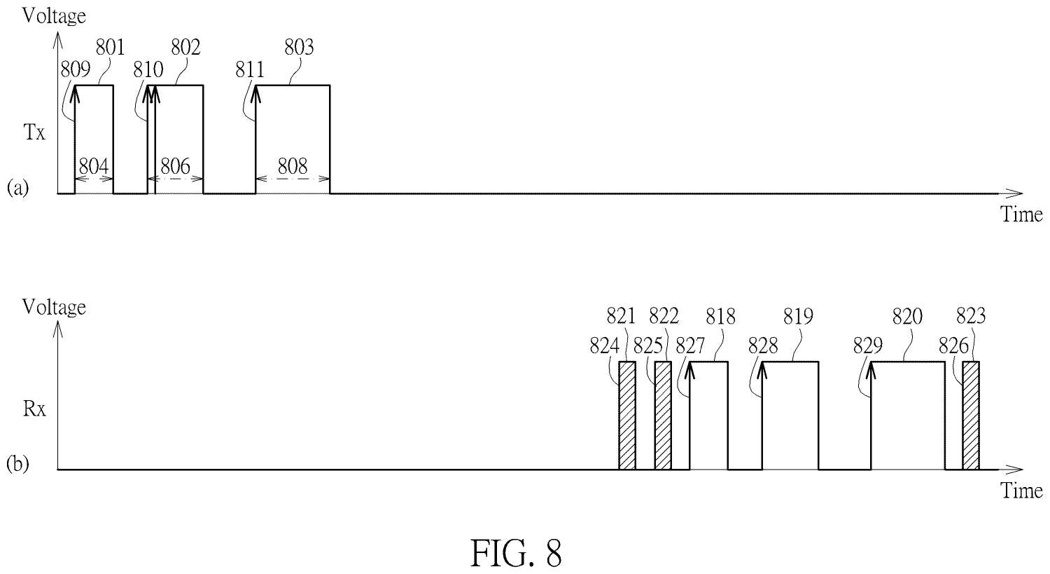

For example, FIG. 8 is a timing diagram for laser pulse emission and returned pulse detection according to an embodiment of the present invention. FIG. 8 (a) illustrates the laser pulse emission (Tx). FIG. 8 (b) illustrates the returned pulse detection (Rx) of a LiDAR system (e.g., 50) in a non-coaxial configuration under the influence of sunlight.

As shown in FIG. 8 (a), upon receiving a triggered signal (e.g., 809), an emitter (e.g., 510) emits a train of arbitrary number of non-visible pulsed laser beams 801-803.

Under a non-coaxial configuration (e.g., FIG. 5), a detector (e.g., 560), as shown in FIG. 8 (b), may receive one returned pulse (e.g., 818, 819, or 820) for each emitted pulse (e.g., 801, 802, or 803), along with noise pulses (e.g., 821, 822, or 823).

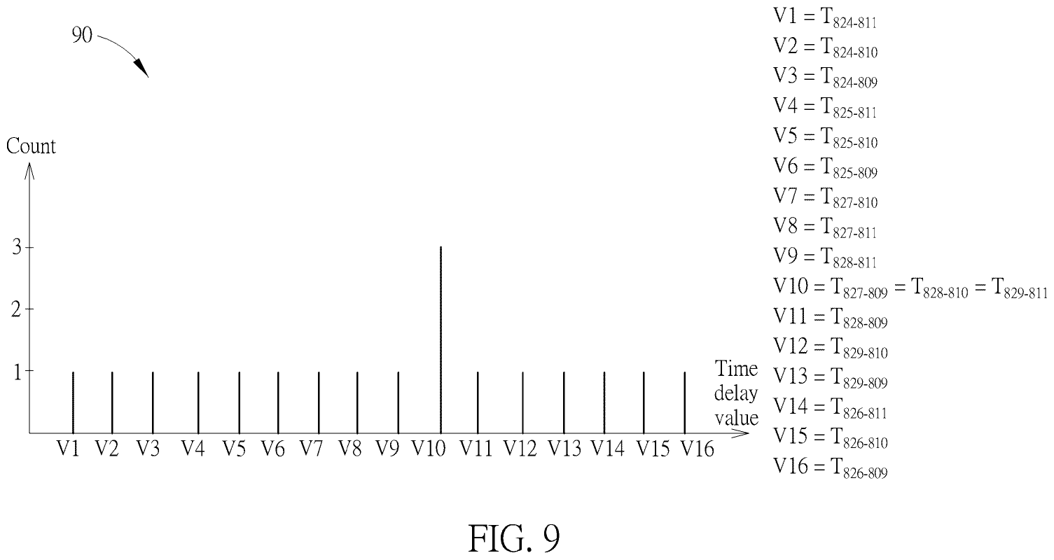

In order to distinguish desired returned pulses from sunlight interference, a histogram 90 of all time delays among returned pulses and emitted pulses is shown in FIG. 9.

Among all the time delays, only the time delays T₈₂₇₋₈₀₉, T₈₂₈₋₈₁₀, and T₈₂₉₋₈₁₁ are substantially identical within the margin of measuring errors; therefore, 3 counts of same time delays are observed.

If the time delays among rising edges of all three emitted pulses 801, 802, and 803 are different, then the rest of the time delays of the returned pulses are all different, thus getting only one count.

Therefore, in this 3-pulses histogram-based measurement, the SNR equals 3.

In the present invention, a LiDAR system that emits multiple laser pulses is disclosed. Besides, the present invention builds a histogram of time delays among emitted and returned pulses to decipher the correct time delay amid sunlight interference.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Light Detection and Ranging (LiDAR) system, comprising:
an emitter, configured to emit a train of pulses; and
a detector, configured to detect noise pulses and a train of returned pulses,
wherein a time delay between each pulse and each returned pulse is calculated,
wherein a time delay between each pulse and each noise pulse is calculated,
wherein a data group is created according to the time delays between the pulses and the returned pulses and the time delays between the pulses and the noise pulses,
wherein the returned pulses are distinguished from the noise pulses according to the data group.

2. The LiDAR system of claim 1, wherein the data group is a histogram or a statistic table,
wherein the returned pulses are distinguished from the noise pulses according to a highest peak of the histogram, or a maximum count of time delays in the statistic table.

3. The LiDAR system of claim 1, wherein pulse widths of the pulses are different or random,
wherein each of the returned pulses substantially has the same pulse width as one of the pulses,
wherein each of the pulses substantially has the same pulse width as at least one of the returned pulses.

4. The LiDAR system of claim 1, wherein time delays between the pulses are different or random,
wherein a time delay between two of the returned pulses is substantially the same as a time delay between two of the pulses.

5. The LiDAR system of claim 1,
wherein time delays between the pulses and time delays between the returned pulses are substantially the same.

6. The LiDAR system of claim 1, wherein pulse widths of the pulses and pulse widths of the returned pulses are substantially the same.

7. The LiDAR system of claim 1, wherein a number of the pulses equals a peak value of the highest peak.

8. The LiDAR system of claim 1, wherein a distance to an object is calculated according to a time delay corresponding to the highest peak.

9. The LiDAR system of claim 1, wherein the LiDAR system is a coaxial optical system,
wherein a number of the returned pulses equals an integer multiple of a number of the pulses or more than the number of the pulses.

10. The LiDAR system of claim 1, wherein the LiDAR system is a non-coaxial optical system,
wherein a number of the returned pulses equals a number of the pulses.

11. A Light Detection and Ranging (LiDAR) method, configured for a LiDAR system, and the LiDAR method comprises:
emitting a train of pulses; and
detecting noise pulses and a train of returned pulses,
wherein a time delay between each pulse and each returned pulse is calculated,
wherein a time delay between each pulse and each noise pulse is calculated,
wherein a data group is created according to the time delays between the pulses and the returned pulses and the time delays between the pulses and the noise pulses,
wherein the returned pulses are distinguished from the noise pulses according to the data group.
